(19) United States
(12) Patent Application Publication
(10) Pub. No.: US 2020/0265694 A1
(43) Pub. Date: Aug. 20, 2020

(54) SYSTEM FOR IMPLEMENTING AN AERIAL SECURITY NETWORK

(71) Applicant: BelleFox, Inc., Santa Clara, CA (US)

(72) Inventors: Ryan Guohong Xu, Los Altos, CA (US); Peiji Chen, San Jose, CA (US)

(21) Appl. No.: 16/280,831

(22) Filed: Feb. 20, 2019

(51) Int. Cl. G08B 13/196; B64D 47/08; B64C 39/02; G06K 9/00; H04N 7/18

(52) U.S. Cl. CPC G08B 13/19689; B64D 47/08; B64C 39/024; B64C 2201/042; H04N 7/185; B64C 2201/127; B64C 2201/146; G06K 9/00771

(57) ABSTRACT

A system to implement an aerial security network utilizing unmanned aerial vehicles (“UAVs”) to provide security surveillance, suspicious activity/target detection and tracking, and deterrence actions for a protected area. The system includes one or more UAVs to capture images or videos of a protected area, a plurality of sensors to provide sensor information, one or more aerial security hubs (ASHs) to receive sensor information from the plurality of sensors, and an aerial security service to detect a suspicious activity in the protected area based on the sensor information. Upon detecting the suspicious activity by the aerial security service, one or more ASHs may instruct one or more UAVs to collect evidence of detected suspicious activity and/or perform defensive actions to deter the suspicious activity. One or more users may be notified of the suspicious activity, may receive a real-time view of the suspicious activity, and may remotely control the UAVs.

### TECHNICAL FIELD

Embodiments of the invention described herein relate generally to an aerial security network. In particular, the disclosure relates to the use of unmanned aerial vehicles to provide security surveillance, suspicious target detection/tracking, and defensive actions against suspicious activities.

### BACKGROUND ART

Security and protection against property loss has been a challenge for suburban communities, industrial parks, and office complexes. Studies have shown that in the U.S., a burglary happens once every 13 seconds and the property loss for each occurrence averages about $300. Unfortunately, fewer than 13% of all burglaries result in a conviction. Clearly, current solutions offer little deterrence to would-be-burglars and are typically not very helpful in the apprehension and conviction of the suspects.

Conventional home security systems tend to rely on surveillance cameras and sensors that are fixed in place. These systems typically have limited viewing and coverage areas because they are confined to the locations of where they are installed. To avoid being tempered with, or even destroyed, by the would-be-burglars, conventional security cameras are typically mounted high off the ground or in hard-to-access locations. These locational constraints tend to result in the cameras having viewing angles and/or viewing distances that are not ideal for capturing suspicious activities or targets. Moreover, once the presence of surveillance cameras is known by the burglars, the effectiveness of these cameras can be severely compromised. For example, these surveillance cameras can easily be defeated by the burglars by simply staying out of the camera's coverage areas or obscuring their faces with masks, sunglasses, and/or other articles of clothing. Additional methods to defeat these fixed-location surveillance cameras include cutting the power, blocking the lens, repositioning the camera, destroying the hardware, etc.

Besides being easily defeated and/or circumvented, conventional security cameras are also not particularly economical. To provide adequate coverage for a large area, such as a suburban neighborhood, a large number of cameras is required. Even then, it is impractical to cover all areas with statically-installed cameras as the cost of the cameras themselves can quickly add up, not to mention all of the additional hassles associated with their installation, such as determining suitable locations, drilling and mounting the hardware, running wires for power and/or data connection, etc. Moreover, since fixed-location security cameras tend to be installed in areas that are difficult to access, any subsequent maintenance and/or repair work are likely to require just as much effort as the initial installation.

### BRIEF DESCRIPTION OF THE DRAWINGS

The invention may best be understood by referring to the following description and accompanying drawings that are used to illustrate embodiments of the invention. In the drawings:

FIG. 1 illustrates an area protected by an aerial security network in accordance to an embodiment of the present invention;

FIG. 2 illustrates a system embodiment of an aerial security network;

FIG. 3 is a block diagram illustrating an embodiment of an aerial security hub;

FIG. 4 is a block diagram illustrating an embodiment of the aerial security service; and

FIGS. 5A and 5B illustrate actions that an unmanned aerial vehicle may take against a suspicious target according to an embodiment.

### DETAILED DESCRIPTION

Embodiments of system and method for implementing an aerial security network are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments. For clarity, individual components in the figures herein may be referred to by their labels in the figures, rather than by a particular reference number.

Typical smart home security solutions use surveillance cameras to passively monitor and record suspicious activities which can be easily defeated and are generally ineffective in disrupting these suspicious activities (e.g., deter or discourage burglars from actually breaking into the house). Aspects of the present invention relate to systems and methods for providing an aerial surveillance network that not only monitors for suspicious activities in a protected area, but also enables the users and/or authorities to take defensive measures that are aimed to discourage and/or stop the suspicious activities from continuing.

Embodiments of the present invention offer a much more versatile solution than conventional surveillance systems. In one embodiment, an aerial surveillance network utilizes unmanned aerial vehicles (UAV) to provide aerial surveillance for a protected area. This provides many advantages over conventional surveillance systems that utilize fixed-location and/or limited-mobility cameras. For example, aerial surveillance can protect large geographic areas, such as a suburban community or an industrial complex, with relatively fewer resources. For instance, coverage of a building that normally requires multiple cameras can be achieved by a single patrolling UAV. In addition to being more economical and cost-efficient, the use of UAVs also reduces the human factors that are typically associated with the use of human security guards, such as fatigue, sickness, distraction, error in judgement, etc.

According to an embodiment, when suspicious activities and/or targets are detected, one or more UAVs may be dispatched to approach the suspicious activities and/or targets. The dispatched UAVs will take the proper flight path to approach the targets and operate onboard recording devices as part of the evidence-collection process. Moreover, in one embodiment, the UAVs not only can take photos and videos of suspicious activities from various heights, distances, and angles, they can also follow or track suspicious activities from one location to another. In addition, the captured photos and videos may also be associated with detailed time and/or locational information. These capabilities drastically increase the quality and usefulness of any evidence collected against the suspicious targets. For instance, UAVs may collect different views of a suspect's face, the break-in activity, the stolen properties, the target's getaway vehicle, the license plate, escape route, etc. In some embodiments, the UAVs can even take defensive actions against the suspicious target when necessary. The UAVs may follow and hover above the suspicious target. The UAVs may continuously or periodically provide the suspicious target's most current location and report them to the appropriate authorities. In addition, the UAVs may broadcast alarm or warning sounds, such as sirens or dog barks, as well as give verbal commands to the suspicious target. In some embodiments, the UAVs may enable a user, such as property owner, police officer, private security, or other authorized personnel, to communicate with the suspicious target. When necessary, the UAVs may take even more aggressive actions such as firing projectiles to disorient or incapacitate the suspicious targets.

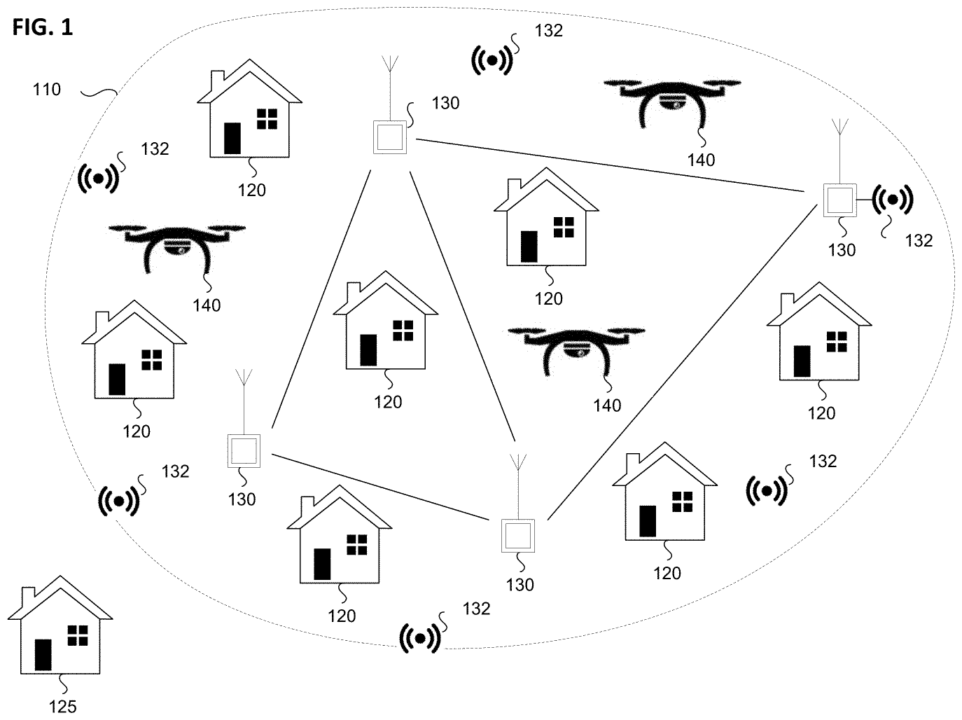

FIG. 1 illustrates an area protected by an aerial security network in accordance to an embodiment of the present invention. The protected area 110 may be a residential community, industrial park, office complex, etc. The protected area may include one or more buildings or structures 120. Examples of buildings and structures 120 include, but are not limited to, houses, apartments, factories, offices, warehouses, garages, barns, sheds, etc. It is a goal of the aerial security network to protect these buildings and structures 120 from intrusion, theft, vandalism, unauthorized accesses, etc. In FIG. 1, building 125 is not in the protected area and is thus not protected by the aerial security network.

The protected area 110 may also include one or more aerial security hubs (“ASHs”) 130. The ASHs 130 may be installed in or near the structures 120 in the protected area 110. In some embodiments, some ASHs 130 may be located outside the protected area. The ASHs 130 may be integrated as part of the structures 120. Alternatively, they may be installed on, or have their own, dedicated platforms. In some embodiments, the ASHs 130 are mounted on telephone poles, power poles, trees, street lights, etc. As least some of the ASHs 130 may include one or more sensors 132. Examples of sensors 132 include, but are not limited to, motion sensors, pressure sensors, acoustic sensors, temperature sensors, light sensors, contact sensors, garage door sensor, radio sensors, surveillance cameras, doorbell cameras, night vision cameras, etc. Sensors 132 may be integrated into some of the ASHs 130 or may be standalone sensors that are separate from the ASHs 130. Some sensors may be provided by the provider or operator of the aerial surveillance network. Other sensors may be special-purpose or off-the-shelf products that are provided by third party manufacturers or suppliers. Sensors 132 may provide sensor information to one or more ASHs 130. The sensor information may include detected results, observed measurements, generated signals, and/or any other appropriate information, such as photos, images, videos. In one embodiment, the sensor information is provided, either directly by the sensors 132 or through the ASHs 130, to an aerial surveillance service. The aerial surveillance service may be a cloud services accessible through the internet and may include one or more remote computing resources or servers. In one embodiment, the aerial surveillance service utilizes algorithms, programs, and/or artificial intelligence to detect or identify suspicious activities and/or suspicious targets based on the received sensor information. The suspicious targets may include one or more persons who are conducting suspicious activities.

The ASHs 130 may serve as base stations to communicate with the UAVs 140. The ASHs 130 may provide instructions, commands, coordinates, and/or flightpath information to the UAVs 140. In one embodiment, the ASHs 130 relays instructions, commands, coordinates, and/or fly path information from the aerial security service to the UAVs 140. According to embodiments of the present invention, at least some of the ASHs 130 include a dock to allow one or more UAVs 140 to dock with the ASH. In one embodiment, any of the UAVs 140 can communicate and dock with any of the ASHs 130 in the aerial surveillance network.

In one embodiment, any one of the one or more of the ASHs 130 may be communicatively connected one or more other ASHs to form a mesh network. The ASHs 130 may be connected to one another using wireless or wired communication channels. The sensors 132 may be connected to the ASHs 130 through direct wireless or wired communication channels and may be part of the mesh network.

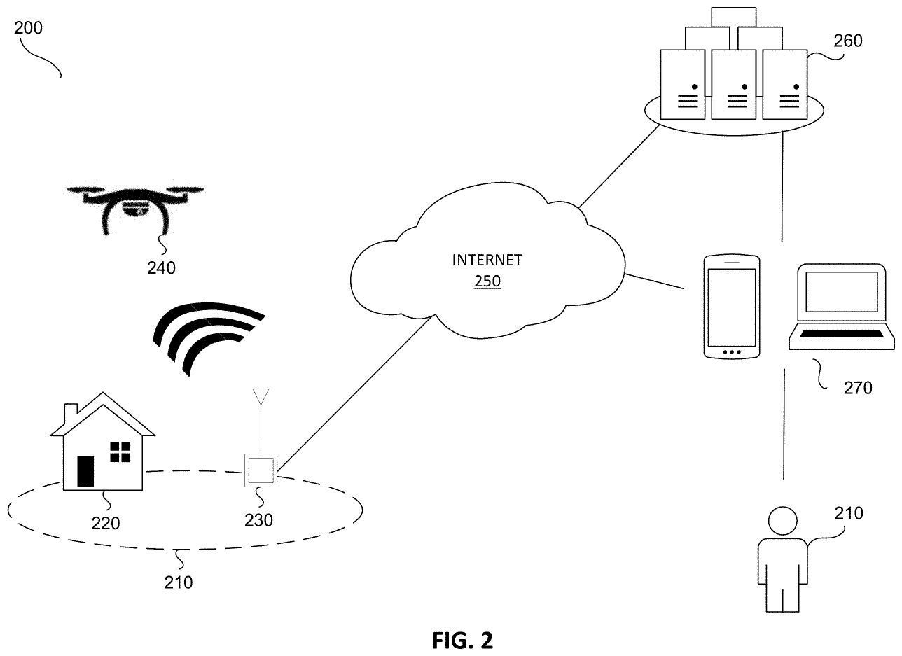

FIG. 2 illustrates a system embodiment of aerial security network. Aerial security network 200 monitors and/or protects one or more buildings or structures 220 in the protected area 210. The aerial security network 200 includes one or more ASHs 230 and one or more UAVs 240 to provide aerial surveillance to the protected area 210.

In one embodiment, the ASH 230 is communicatively coupled to an aerial surveillance service 260. The aerial surveillance service 260 may be a cloud service and may comprise of one or more computing resources or servers. According to an embodiment, the ASH 230 and the aerial surveillance service 260 are connected through the internet 250. In other embodiments, the ASH 230 and the aerial surveillance service 260 are connected through a dedicated connection and/or other networks, such as wide area network (WAN), local area network (LAN), cellular network, etc. The communication between ASH 230 and aerial surveillance service 260 may be encrypted.

As noted above, the aerial surveillance service 260 receives sensor information from the ASH 230 or directly from the sensors. The sensor information is analyzed by the aerial surveillance service 260 using algorithms, programs, and/or artificial intelligence to detect or identify suspicious activities and/or suspicious targets. In one embodiment, when suspicious activities or targets are detected, one or more users 210 are notified. The users 210 may access the aerial surveillance service 260 using client device 270. Examples of client device 270 may include mobile phones, smart phones, desktop computers, laptop computers, tablets, etc. The client device 270 may comprise, or have installed thereon, software programs, mobile applications, or web browsers for accessing the aerial surveillance service 260. The client device 270 may communicate with the aerial surveillance service 260 directly through a dedicated connection, the internet 250, or other networks. Such communication may also be encrypted.

According to some embodiments, user of client device 270 may access ASH 230 or the UAV 240 through the aerial surveillance service 260. Alternatively or in addition to, the client device 270 may access ASH 230 or UAV 240 directly without going through the aerial surveillance service 260, such as by going through the internet 250 or other networks (not shown). These networks may include a local, cellular, or WIFI networks. Examples of the access referred to herein include sending and/or receiving instructions, commands, photos, images, videos, audios, live feeds, etc. In one embodiment, by accessing the ASH 230, either directly or through the aerial surveillance service 260, the user 210 of client device 270 can provide instructions or commands to control the UAV 240, to view photos, images, videos, live feeds captured by the UAV 240, to listen to audios or sounds captured by the UAV 240, or to broadcast audio or sounds through speakers on the UAV 240. According to an embodiment, the user 210 may initiate an audio/video conversation through the UAV 240 with a suspicious target.

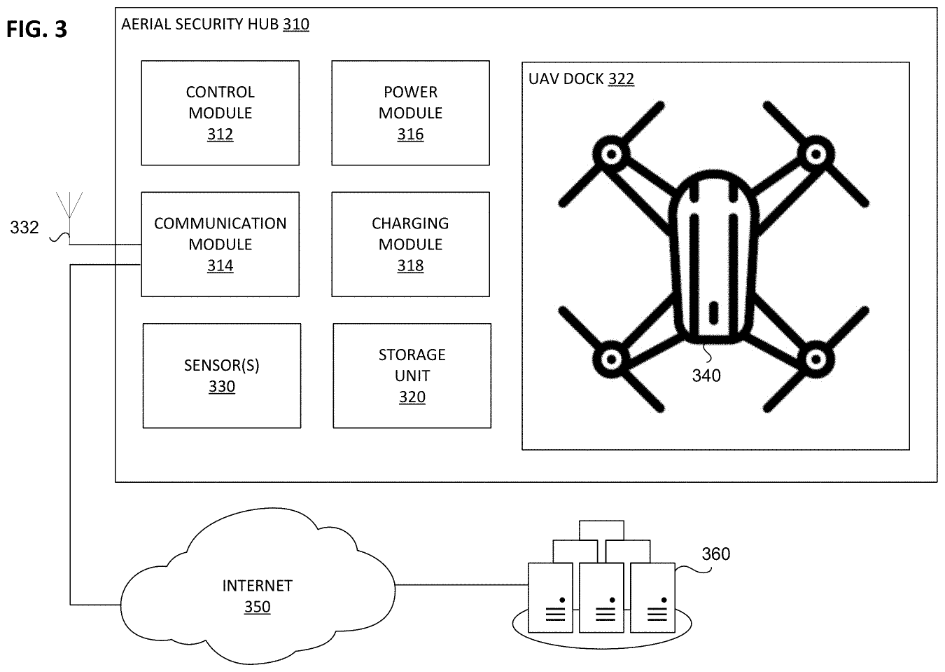

FIG. 3 is a block diagram illustrating an embodiment of the ASH. ASH 310 may include control module 312, communication module, 314, power supply 316, charging module 318, storage unit 320, and UAV dock 322. The control module 312 may include one or more processors or cores to execute program codes or instruction stored on memory module(s) or hard disk drive(s) to control and/or perform various functions of the ASH 310. The functions may include, but are not limited to, generate control commands for the UAV, provide coordinates or flightpath information to the UAV, transmit data collected from sensors or UAVs to an aerial security service or a user device, detect suspicious activity/target, perform software/firmware updates to the UAV, etc. The program codes and instructions may be provided, installed, and/or operated by the aerial security service.

The communication module 314 may include one or more communication interfaces such as ethernet, cellular, WIFI, Bluetooth interfaces, etc. The communication module 314 enables the ASH 310 to communicate with the UAV 340, the aerial security service 360, integrated and/or external sensors 330, as well as other ASHs. For example, through the communication module 314, the ASH 330 may receive sensor information from the sensors 330. The ASH 310 may also transmit and receive data to and from the UAV 340 and the aerial security service 360 through communication module 314. The data may include control commands, instructions, coordinates, flightpath information, sensor information, photos, images, videos, audios, live feeds, software/firmware upgrades, etc. Communication between the ASH 310 and the UAV 340 may occur when the UAV 340 is in the air and/or when it is docked in the UAV dock 322. Communication between the ASH 310 and the aerial surveillance service 360 may be through the internet or other networks. According to an embodiment, the communication module 314 may further include one or more antennas 332.

The power supply 316 provides power to the ASH 310. It may be connected to an external power source such as a wall outlet or a power generator (e.g., solar, wind, etc.). The power supply 316 may supply power to the charging module 318, which charges the UAV 340 when it is docked in the UAV dock 322. According to an embodiment, multiple UAVs 340 may be docked in the UAV dock and charged at the same time.

The storage unit 320 stores the data received from the UAV 340 and/or the aerial security service, as well as sensor information from the sensors 340. Photos or videos that are captured by the UAV 340 may first be transmitted from the UAV 340 to the ASH 310 and stored in the storage unit 320 before they are transmitted to the aerial security service. In one embodiment, the ASH 310 may receive software or firmware updates for the UAV 340 which are then stored in the storage unit 320. When UAV 340 is docked in the UAV dock 322 and receiving power from the charging module 318, the control module 312 may initiate the update process to install the stored software or firmware updates on the UAV 340.

The UAV dock 322 may include one or more stations in which one or more UAVs 140 may dock or land. Once docked, the ASH 130 may provide power to charge the UAVs 140 or to perform software/firmware updates. The UAV dock 322 may include logic to provide landing guidance to direct the UAVs 140 to land accurately and properly in specific areas (i.e. stations) of the UAV dock 322. The UAV dock 322 may also include mechanisms (e.g., latches, connectors, contacts) that may be automatically attached to or detached from the UAVs. For example, one or more latches may secure an UAV in place when it is docked and detach when the UAV is ready to launch. A set of connectors may automatically couple to a docked UAV to charge the UAV's battery and may automatically decouple when the charging is complete.

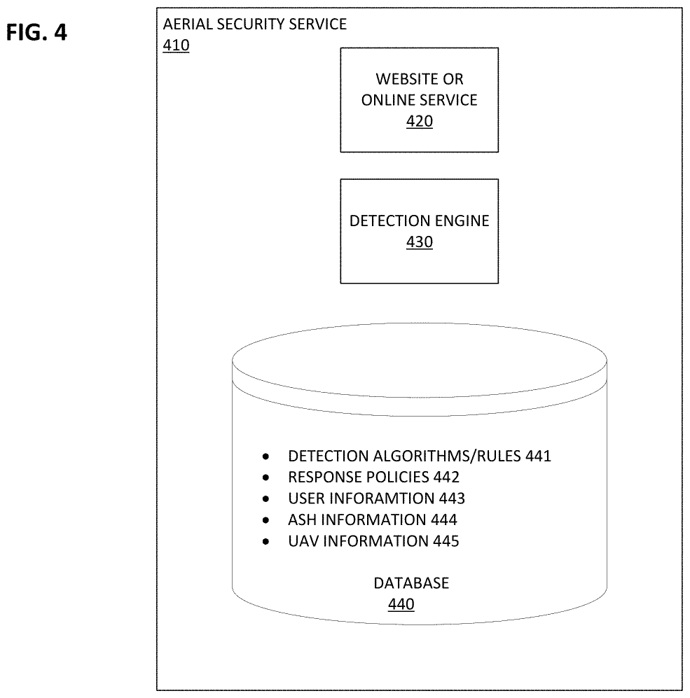

FIG. 4 is a block diagram illustrating an embodiment of the aerial security service. Aerial security service 410 may host a website, web application, or an online service 420 through which a user of a client device may access the aerial security service 410. A detection engine 430 analyzes information collected by various sensors, UAVs, and ASHs of the aerial surveillance network. Based on these information, the detection engine 430 detects or identifies potential suspicious activities and/or targets in the protected area. A database 440 stores detection algorithms or rules 441, response policies 442, user information 443, ASH information 444, and/or UAV information 445. The detection algorithms or rules 4441 may be used by the detection engine 430 to detect suspicious activities and/or targets. Once suspicious activities or targets are detected, response policies 442 provides the appropriate actions to be taken. If one or more users should be notified, user information 443 is accessed for the appropriate contact methods or contact information. If one or more UAVs are to be dispatched for evidence collection or deterrence purposes, the ASH information 444 and UAV information 445 are accessed so the commands or instructions can be send to the appropriate ASHs for operating the UAVs.

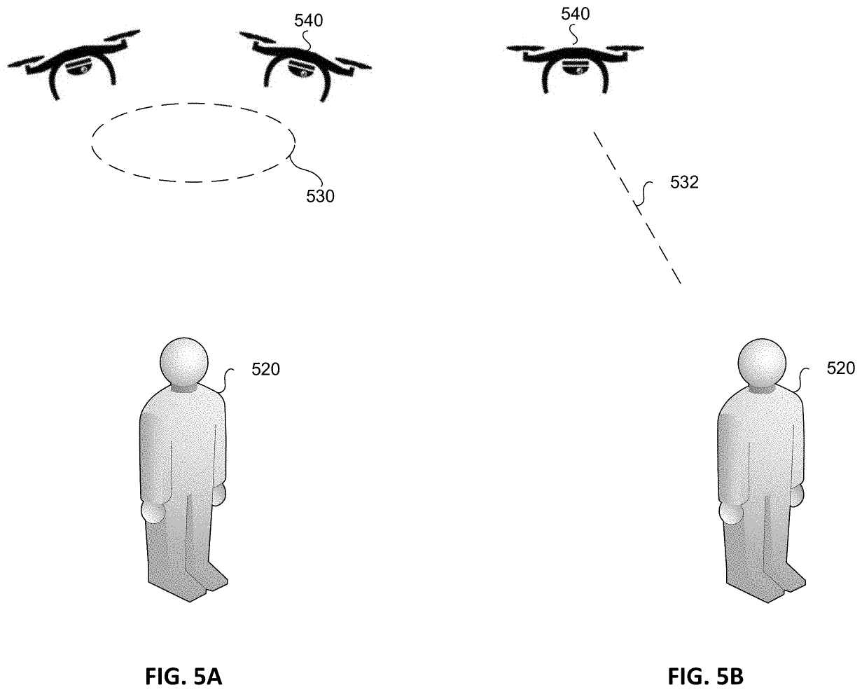

FIGS. 5A and 5B illustrate some of the actions that an UAV may take against a suspicious target. In FIG. 5A, the UAV 540 may take a specific flight path, such as a circular pattern 530, around the suspicious target 520 to distract the suspicious target and/or to collect photo or video evidence from various angles. In FIG. 5B, the UAV 540 may trail the suspicious target 520 at a fixed distance 532. The fixed distance may be a safe distance from the suspicious target to prevent the suspicious target from attempting to destroy or temper with the UAV 540.

Although some embodiments have been described in reference to particular implementations, other implementations are possible according to some embodiments. Additionally, the arrangement and/or order of elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. The terms used in the following claims should not be construed to limit the invention to the specific embodiments disclosed in the specification and the drawings. Rather, the scope of the invention is to be determined entirely by the following claims, which are to be construed in accordance with established doctrines of claim interpretation.

What is claimed is:

1. A system for implementing an aerial security network, the system comprising:
one or more unmanned aerial vehicles (UAVs) to capture images or videos of a protected area;
a plurality of sensors to provide sensor information, the sensor information indicating activities in the protected area;
one or more aerial security hubs (ASHs) located in or near the protected area and communicatively coupled to the plurality of sensors, the one or more ASHs receiving sensor information from the plurality of sensors; and
program code to be installed and operated by an aerial security service to enable the aerial security service to receive the sensor information from the one or more ASHs, the aerial security service to detect a suspicious activity in the protected area based on the sensor information;
wherein upon detecting the suspicious activity by the aerial security service, at least one of the one or more ASHs is to instruct a first UAV of the one or more UAVs to capture images and/or videos of the detected suspicious activity.

2. The system of claim 1, wherein the plurality of sensors comprises at least one of a motion sensor, pressure sensor, acoustic sensor, temperature sensor, light sensor, contact sensor, garage door sensor, radio sensor, surveillance camera, doorbell camera, or night vision camera.

3. The system of claim 1, wherein some of the plurality of sensors are integrated into one or the one or more ASHs.

4. The system of claim 1, wherein some of the plurality of sensors are external sensors that are separate from the one or more ASHs.

5. The system of claim 1, wherein a first ASH of the one or more ASHs comprises a dock to allow at least one of the one or more UAVs to dock with the first ASH.

6. The system of claim 5, wherein the first ASH is to provide power to charge a UAV docked in the first ASH.

7. The system of claim 1, wherein the first UAV is programmed with logic to take a proper flight path to approach the detected suspicious activity.

8. The system of claim 1, wherein the first UAV is programmed with logic to adjust a position of the first UAV or an angle of a camera on the first UAV to take images or videos of the suspicious activity from different perspectives.

9. The system of claim 1, wherein the first UAV is programmed with logic to follow the suspicious activity or a person associated with the suspicious activity.

10. The system of claim 9, wherein the first UAV is further programmed with logic to hover on top of the suspicious activity or the person associated with the suspicious activity.

11. The system of claim 1, wherein the one or more UAVs are to take periodic surveillance flights to survey the protected area and to take images or videos of the surveyed area.

12. The system of claim 11, wherein the one or more UAVs are to transmit results of the periodic surveillance flights to the one or more ASHs or the aerial security service.

13. The system of claim 1, wherein upon detecting the suspicious activity by the aerial security service, the aerial security service is to notify a user by sending a notification to a client device of the user.

14. The system of claim 13, wherein the user can send command through the client device to control the first UAV.

15. The system of claim 14, wherein the first UAV comprises a speaker and a microphone to conduct an audio conversation between the user and a person associated with the suspicious activity.

16. The system of claim 13, wherein the user is an owner of a property in the protected area, a police officer, a private security personnel, or other authorized personnel.

17. The system of claim 13, wherein the user commands the one or more UAVs to take surveillance flights to a specified destination and to provide the user with a real-time view of the surveillance flight.

18. The system of claim 1, wherein the one or more UAVs can communicate with any of the one or more ASHs.

19. The system of claim 1, wherein the one or more UAVs can dock with any of the one or more ASHs.

20. The system of claim 1, wherein any of the one or more ASHs can communicate with any of the other ASHs to form a mesh network.
